(19) United States
(12) Patent Application Publication
(10) Pub. No.: US 2011/0114794 A1
(43) Pub. Date: May 19, 2011

(54) ENVIRONMENTAL COMPRESSION FOR FRICTION REDUCTION

(76) Inventor: Calvin B. BOZE, Bragg Creek (CA)

(21) Appl. No.: 12/622,261

(22) Filed: Nov. 19, 2009

(51) Int. Cl. B64C 21/10

(52) U.S. Cl. 244/200

(57) ABSTRACT

A viscous drag-reducing surface is provided that achieves harmony between an object and the environment (liquid or gas) through which the object moves. Rather than opposing the effects of friction, the surface according to the present invention eliminates friction by bonding the environment to the object. The pressure generated on the object by the environment as the object moves through the environment effectively compresses the local environment onto the surface. Once compressed against the surface, the local environment in contact with the surface becomes static relative to the surface whereas the environment that is not in contact with the surface achieves a laminar flow. Friction is thereby significantly reduced, since friction between like substances (i.e. the in-contact environment and the environment that is not in contact with the surface) is minimal.

### BACKGROUND OF THE INVENTION

1. Field of the Invention

The present invention is directed to surfaces that are designed to reduce friction drag at an interface between a moving object and its environment, and more particularly to a surface that bonds to the fluid environment (liquid or gas) through which an object moves.

2. Description of the Related Art

Before describing the background art and unique aspects of the present invention, a brief description is provided of the terminology and scientific principles relevant to the present invention. A fluid is a substance that continually deforms (i.e. flows) under an applied shear stress. All gases are fluids, but not all liquids are fluids. Fluids include liquids, gases, plasmas and, to some extent, plastic solids.

Friction is a force that resists the relative lateral (tangential) motion of solid surfaces, fluid layers, or material elements. Friction is usually subdivided into several varieties: dry friction, lubricated friction, fluid friction, skin friction and internal friction. When an object moves relative to its environment (which can be another surface, air, liquid, etc.), the friction between the object and environment converts kinetic energy into thermal energy, or heat. Contrary to earlier explanations, kinetic friction is now understood not to be caused by surface roughness but by chemical bonding between an object's surface and the environment through which it moves.

Previous approaches to solving the problem of friction have been many and various. They fall into two categories: solutions that attempt to minimize the effects of friction, and solutions that attempt to reduce friction itself by modifying the surface of a moving object. Solutions that attempt to minimize the effects of friction include the use of stronger materials, heat resistant materials and anti-corrosive materials, whereas solutions that attempt to reduce friction itself include aerodynamic and hydrodynamic design, streamlining and the use of lubricants. All of these approaches are useful for reducing or withstanding friction, however they do not completely eliminate friction itself.

These previous approaches have a common disadvantage in that they are all designed to oppose the effects of friction. For example, aerodynamic designs attempt to oppose friction by reducing its effects while the use of stronger materials attempts to oppose friction by withstanding its effects for longer periods of time. Nonetheless, any material that is exposed to friction eventually heats up, breaks down, breaks up, corrodes and/or melts. Consequently, irrespective of which prior art approach to opposing friction is chosen, any object that passes or moves through its surrounding environment will be impeded by the effects of friction and will ultimately be incapable of movement at full efficiency.

### SUMMARY OF THE INVENTION

It is an aspect of the present invention to provide a viscous drag-reducing surface that achieves harmony between an object and the environment (liquid or gas) through which the object moves. Rather than opposing the effects of friction, as in the prior art, the surface according to the present invention eliminates friction by bonding the environment to the object. The pressure generated on the object by the environment as the object moves through the environment effectively compresses the local environment onto the surface. Once compressed against the surface, the local environment in contact with the surface becomes static relative to the surface whereas the environment that is not in contact with the surface achieves a laminar flow. Friction is thereby significantly reduced, since friction between like substances (i.e. the in-contact environment and the environment that is not in contact with the surface) is minimal.

The above aspects can be attained by an object adapted to move through an environment, the object comprising a body having at least one viscous drag-reducing surface with at least one crease surrounded by at least one roll, for bonding the environment to the object by compressing the environment into the at least one crease as the object moves through the environment, thereby reducing viscous drag between the object and the environment.

Further objects can be attained by a surface for application to an object adapted to move through an environment, said surface comprising at least one crease surrounded by at least one roll, for bonding said environment to the surface by compressing the environment into said at least one crease as said object moves through said environment, thereby reducing viscous drag between said surface and the environment.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A is a plan view of a surface having rolls and creases according to an embodiment of the invention, and FIG. 1B is a cross-sectional view thereof;

FIG. 2 is a perspective view of an object to which the surface of FIGS. 1A and 1B may be applied, according to an exemplary embodiment;

FIGS. 3A and 3B are perspective views of first and second alternative embodiments of a surface according to the present invention, and FIGS. 3C and 3D are plan and perspective views of a third alternative embodiment; and

FIGS. 4A-4G are plan views of additional shapes of surface and configurations of rolls and creases, according to further alternative embodiments.

### DETAILED DESCRIPTION OF THE PREFERRED EMBODIMENTS

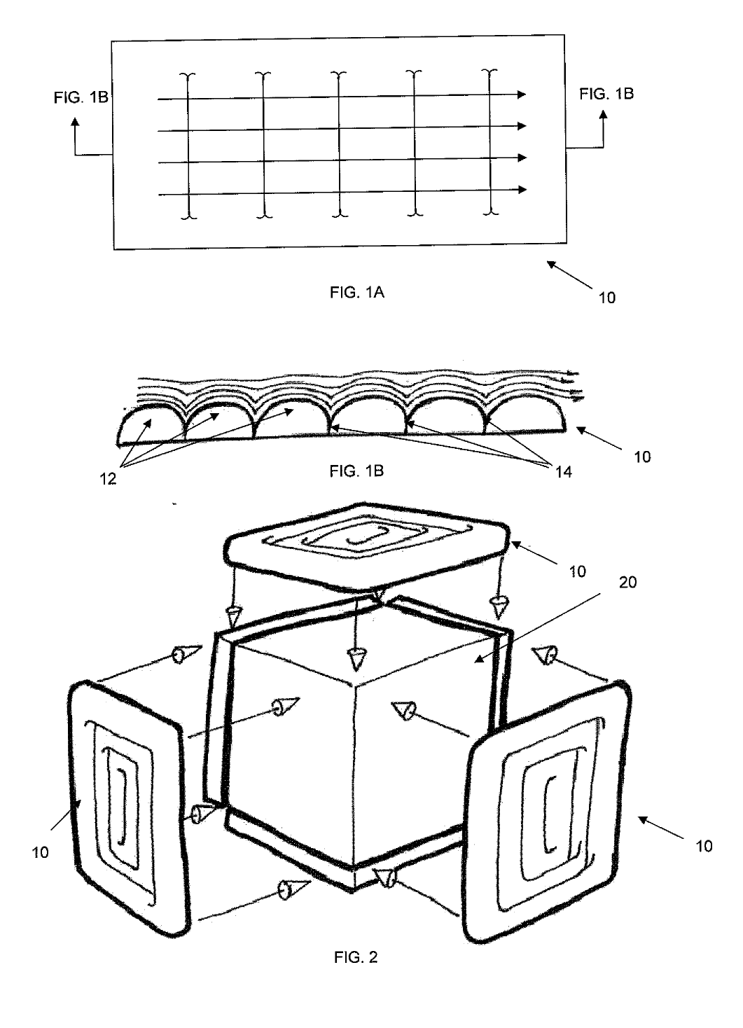

With reference to FIGS. 1A and 1B, a surface (10) according to an embodiment of the invention is shown, which is adapted to be applied to or be integral with an object, as discussed in greater detail below with reference to FIG. 2. The surface (10) is smooth and comprises a plurality of alternating rolls (12) and creases (14) adapted to bond with the environment through which the surface moves (see the flow direction arrows in FIG. 1A). The pressure generated on the surface (10) as it passes through its environment (e.g. air, water, etc.) compresses the environment into the creases (14), as indicated by the path of flow lines immediately adjacent the surface (10) in FIG. 1B. The environment thereby compressed into the creases (14) becomes static (i.e. does not move relative to the surface (10)) whereas the environment that is not in contact with the surface (10) achieves a laminar flow, as indicated by the path of flow lines not immediately adjacent the surface (10). Friction between the environment immediately adjacent the surface (10) and the environment not immediately adjacent the surface (10) is minimal.

The preferred cross-sectional shape of the alternating rolls (12) and creases (14) is a cycloid (i.e. a line generated by a point on a circle rolling along a straight line). However, a person of skill in the art will understand that other shapes are possible, provided that the cross-sectional shape of alternating rolls (12) and creases (14) is such that the environment bonds to the surface within the creases, as discussed above.

The size of the rolls (12) and the depth of the creases (14) are determined by the nature of the environment (e.g. whether the environment is gas, liquid, etc.), while the orientation of the rolls and creases relative to direction of movement are determined by the requirements of the shape of the object to which the surface (1) is applied or made integral with.

FIG. 2 shows a plurality of surfaces (10) being applied to the body (20) of an object. In FIG. 2, the body (20) is a cube, but the invention is not in any way limited to the shape of object. Where the surface (10) is not integral with the object (2), the surface may be engraved, stamped, glued, welded or otherwise applied or attached to the body (20).

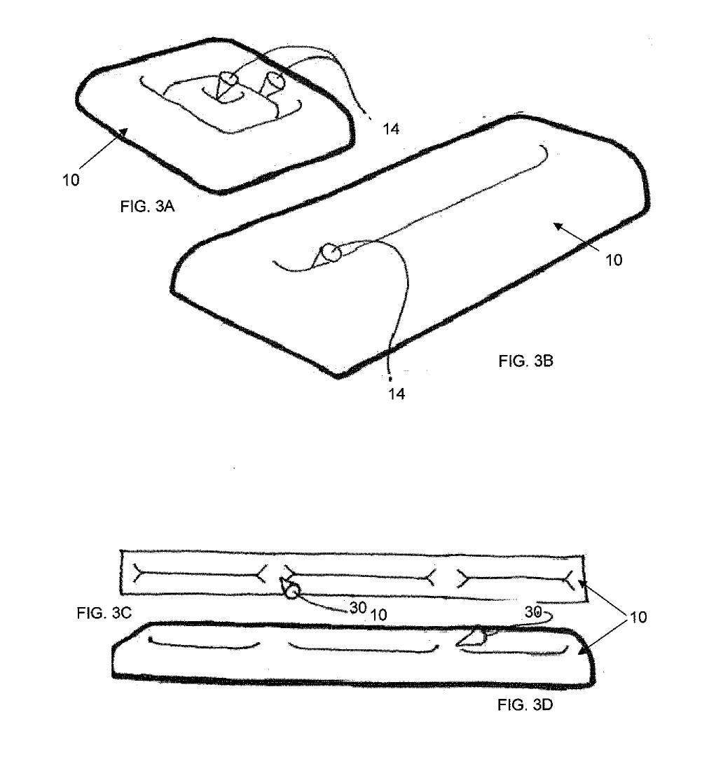

FIG. 3A shows an embodiment wherein the creases (14) form concentric squares within the surface (10), while FIG. 3B depicts a generally rectangular surface (10) incorporating a single crease (14). FIG. 3C shows a further embodiment of generally rectangular surface (10) having multiple co-linear creases that are partitioned (30) one from another. From the embodiments depicted in FIGS. 1-3, it will be apparent that creases (14) may be contained (FIGS. 2 and 3A), partitioned (FIG. 3C), parallel (FIG. 1) or any other suitable configuration.

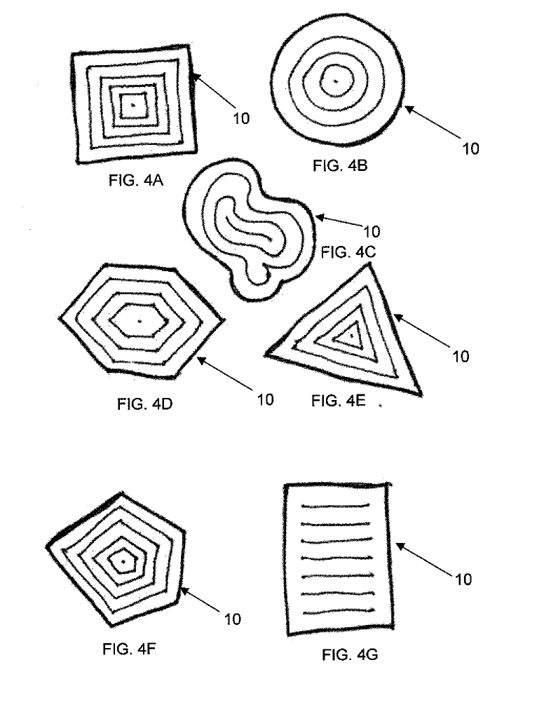

FIGS. 4A-4G are plan views of additional shapes of surface (10) and configurations of rolls (12) and creases (14), according to further alternative embodiments.

It will be appreciated from the foregoing that many alternatives and variations of the shape of surface (10) and the configuration of rolls (12) and creases (14) are possible. In order to maximize efficiency, the size and shape of the rolls (12), the containment and partitioning of the creases (14) and the configurations of the rolls and creases may be selected to best fit any of a multiplicity of applications where friction reduction is desirable, such as: the design of farming equipment (e.g. blades, disks, etc.); in architecture (e.g. roofing, siding, ducting, etc.); transportation (e.g. engines, electric motors, pipes and hoses, aerodynamics, tractors and trailers, motorcycles, helmets, snowmobiles, bicycles, bridges, high-speed trains, shipping containers, ships' hulls, propellers, sails, airplanes, helicopters, rockets. space shuttle surfaces, etc.); sports (e.g. baseball bats, tennis rackets, golf clubs, golf balls, etc.)

The many features and advantages of the invention will be apparent from the detailed specification above and, thus, it is intended by the appended claims to cover all such features and advantages of the invention that fall within the sphere and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. An object adapted to move relative to its environment, the object comprising a body having at least one viscous drag-reducing surface with at least one crease surrounded by at least one roll, for bonding said environment to the object by compressing the environment into said at least one crease as said object moves relative to said environment, thereby reducing viscous drag between said object and the environment.

2. An object in accordance with claim 1 wherein said surface comprises a plurality of creases.

3. An object in accordance with claim 2 wherein said creases are contained one within another within said surface.

4. An object in accordance with claim 2 wherein said creases are partitioned one from another within said surface.

5. An object in accordance with claim 2 wherein said creases are arranged in parallel within said surface.

6. An object in accordance with claim 1 wherein said at least one crease surrounded by at least one roll has a cycloid cross-sectional shape.

7. An article in accordance with claim 1 wherein said surface is integral with said object.

8. An article in accordance with claim 1 wherein said surface is applied to said object.

9. An article in accordance with claim 1 wherein dimensions of said at least one crease and said at least one roll are selected in accordance with the nature of said environment.

10. A surface for application to an object adapted to move relative to its environment, said surface comprising at least one crease surrounded by at least one roll, for bonding said environment to the surface by compressing the environment into said at least one crease as said object moves relative to said environment, thereby reducing viscous drag between said surface and the environment.

11. A surface in accordance with claim 10 comprises a plurality of said creases.

12. A surface in accordance with claim 11 wherein said creases are contained one within another.

13. A surface in accordance with claim 11 wherein said creases are partitioned one from another.

14. A surface in accordance with claim 11 wherein said creases are arranged in parallel.

15. A surface in accordance with claim 10 wherein said at least one crease surrounded by at least one roll has a cycloid cross-sectional shape.

16. A surface in accordance with claim 10 wherein dimensions of said at least one crease and said at least one roll are selected in accordance with the nature of said environment.
